(19) United States
(12) Patent Application Publication
(10) Pub. No.: US 2025/0105310 A1
(43) Pub. Date: Mar. 27, 2025

(54) COMPONENT FOR FUEL CELL

(71) Applicants: SAFRAN, Paris (FR); CENTRE NATIONAL DE LA RECHERCHE SCIENTIFIQUE, Paris (FR); UNIVERSITE DE BORDEAUX, Bordeaux (FR); INSTITUT POLYTECHNIQUE DE BORDEAUX, Talence (FR)

(72) Inventors: Marjorie Christine CAVARROC, Moissy-Cramayel (FR); Fabrice Claude Michel MAUVY, Canejan (FR); Angéline Nadine Jeanne POULON, Arsac (FR); Aurélie Corinne ACHILLE, Saint-Gelais (FR); Dominique Paul Abel MICHAU, Pessac (FR); Sébastien FOURCADE, Leognan (FR)

(73) Assignees: SAFRAN, Paris (FR); CENTRE NATIONAL DE LA RECHERCHE SCIENTIFIQUE, Paris (FR); UNIVERSITE DE BORDEAUX, Bordeaux (FR); INSTITUT POLYTECHNIQUE DE BORDEAUX, Talence (FR)

(21) Appl. No.: 18/729,755

(22) PCT Filed: Jan. 17, 2023
(86) PCT No.: PCT/FR2023/050057

§ 371 Date: Jul. 17, 2024

(30) Foreign Application Priority Data
Jan. 21, 2022 (FR) FR2200497

(51) Int. Cl. H01M 8/0228; C25B 9/60; H01M 8/0243; H01M 8/086; H01M 8/10; H01M 8/1018

(52) U.S. Cl. CPC H01M 8/0228; C25B 9/60; H01M 8/0243; H01M 8/086; H01M 8/1018; H01M 2008/1095

(57) ABSTRACT

A component for an acid electrolyte fuel cell or electrolyser provided with an anticorrosion coating, as well as such an acid electrolyte fuel cell or electrolyser, the component including an electrically conductive substrate, and an anticorrosion coating deposited on at least one surface of the substrate, the anticorrosion coating including at least one main tantalum-nitride-based layer doped with one or more dopant elements chosen from the family of the transition metals or lanthanides.

### TECHNICAL FIELD

The present disclosure relates to a component for an acid electrolyte fuel cell or electrolyser provided with an anticorrosion coating, as well as such an acid electrolyte fuel cell or electrolyser.

Such a component, having an electrical conduction function, can in particular equip a proton-exchange membrane fuel cell (PEMFC) or a phosphoric acid fuel cell (PAFC).

### PRIOR ART

Conductive components, such as end plates, bipolar plates and interconnectors, used in fuel cells are exposed to both oxidising conditions, due in particular to the presence of molecular oxygen and/or water, and corrosive conditions, due in particular to acid effluents coming from the electrolyte, that are extremely harsh, leading in the absence of adequate protection to a rapid deterioration inducing a loss of conductivity of these components as well as to pollution of the environment of the fuel cell, in particular of its electrolyte and/or its catalysts, by the products resulting from this corrosion.

In order to limit this corrosion, a first option is to use very specific alloys which have a natural high resistance to corrosion. This may, in particular, be Inconel 625. However, such special alloys are expensive. Moreover, their natural resistance to corrosion may prove insufficient in certain applications.

A second option is to use more conventional materials for such conductive components, but to protect them using an anticorrosion coating. Many materials have thus been tested in the scientific literature, and in particular coatings of graphite or conductive metal oxides.

However, in addition to very good protective properties against corrosion, this anticorrosion coating must also have good stability and sufficient electrical conductivity so as not to hinder the electrical operation of the fuel cell. In particular, the conductivity of the coating must remain greater than 100 S/cm. Moreover, the coating must be sufficiently thin, for example less than 5 μm, in order not to modify the geometry of the component, especially when the latter comprises channels.

However, to date, both in the field of proton-exchange membrane fuel cells (PEMFC) and in that of phosphoric acid fuel cells (PAFC), the only known solution that can attain a service life greater than 5000 hours and an acceptable rate of deterioration (less than 40 μV/h), is a coating of pure gold with a thickness of 200 to 500 nm.

However, it can be easily understood that such a coating of pure gold significantly increases the cost of the fuel cell. Thus, when all of the conductive components of the fuel cell are equipped with such a coating, the cost of this coating can by itself represent half the total cost of the fuel cell. Moreover, even the pure gold coating finishes by partially wearing, thus polluting the fuel cell environment: in particular, gold particles can be deposited on certain components of the fuel cell and create electrical connections at undesired locations, which reduces the efficiency of the fuel cell.

There is therefore a real need for a component for an acid electrolyte fuel cell or electrolyser, as well as for an acid electrolyte fuel cell or electrolyser comprising such a component, which are at least partially devoid of the disadvantages inherent in the above-mentioned known configurations.

### DISCLOSURE OF THE INVENTION

The present disclosure relates to a component for an acid electrolyte fuel cell or electrolyser, comprising
an electrically conductive substrate, and
an anticorrosion coating, deposited on at least one surface of the substrate,
wherein the anticorrosion coating comprises at least one main tantalum-nitride-based layer doped with one or more dopant elements chosen from the family of transition metals or lanthanides.

As will be specified below in the detailed description, such a tantalum nitride layer doped in this way offers very good protection against corrosion, while having good electrical conductivity. In particular, the inclusion of one or more dopants can increase the chemical stability of tantalum nitride, which is usually metastable, by forming solid solutions.

The component thus obtained is therefore capable of ensuring its current conduction function in an efficient and sustainable manner, despite the strongly oxidising conditions prevailing in the fuel cell or electrolyser.

In particular, due to the high stability of the doped tantalum nitride, the coating does not degrade in practice over time: there is thus a reduced risk, on the one hand, of seeing the conductivity of the component reducing over time and, on the other hand, of polluting the environment of the fuel cell or electrolyser, in particular its electrolyte or its catalysts, and therefore reducing its efficiency. Thus, such a coating makes it possible to achieve an extremely long service life for the component, of order 20,000 to 30,000 hours.

Furthermore, the cost of obtaining a doped tantalum nitride coating is significantly lower than that of a pure gold coating, which can strongly reduce the overall cost of the fuel cell or electrolyser.

Tantalum nitride also has the advantage of remaining stable up to approximately 3000° C., which allows its use in a very large range of applications, including at very high temperature.

In certain embodiments, the main layer is substantially made of tantalum nitride doped with one or more dopant elements chosen from the family of transition metals or lanthanides. The main layer is thus substantially uniform.

In certain embodiments, the main layer is two-phase or multi-phase. In particular, the main layer can have a composition gradient, for example in the direction perpendicular to the substrate.

In certain embodiments, the main layer is made substantially of tantalum nitride. By contrast, the main layer can have a variation in composition affecting the crystalline structure and/or the doping of the tantalum nitride. In particular, a crystalline structure gradient has the advantage of improving the accommodating of stresses between the coating and its substrate, which improves the mechanical properties of the entire system, while limiting cracks and/or delamination of the coating.

In certain embodiments, the electrolyte of the fuel cell or electrolyser is a proton-exchange membrane.

In certain embodiments, the electrolyte of the fuel cell or electrolyser is phosphoric acid.

In certain embodiments, the component has an electrical conduction function within the fuel cell or electrolyser. In particular, the component can be an end plate, a bipolar plate or even an interconnector for a fuel cell or electrolyser.

In certain embodiments, the substrate is metallic.

In certain embodiments, the substrate is made of steel. It may be, in particular, stainless steel, for example Inox 316L. More specifically, due to the anticorrosion protection provided by the anticorrosion coating, it is possible to use a relatively inexpensive material for the substrate, which is, in particular, the case for Inox, even if it does not intrinsically have very high anticorrosion properties.

In certain embodiments, the substrate is made of titanium, aluminium, nickel or an alloy based on at least one of these elements. These metals are also relatively inexpensive.

In certain embodiments, the substrate is non-metallic. It can be, in particular, made of graphite or a composite material, for example with an organic or ceramic matrix.

In certain embodiments, the crystal system of the tantalum nitride of the main layer is hexagonal. More specifically, in addition to excellent corrosion resistance, hexagonal tantalum nitride has a conductivity that is almost as good as that of gold.

In certain embodiments, the crystal system of the tantalum nitride of the main layer is cubic. More specifically, although slightly less conductive than hexagonal tantalum nitride, cubic tantalum nitride also has excellent corrosion resistance, especially when it is doped, as is the case here.

In certain embodiments, the total content of dopants within the main layer is between 1 ppm and 10 at. %, preferably between 10 ppm and 1 at. %, more preferably between 0.2 and 0.5 at. %.

In certain embodiments, the main dopant element is chosen from zirconium, hafnium, vanadium, titanium, niobium, chromium or molybdenum.

In certain embodiments, the dopant element used, preferably uniquely, is vanadium (V). Indeed, vanadium very easily forms a solid solution with tantalum nitride, which increases its stability. Moreover, vanadium oxidises with difficulty: consequently, even if a small fraction of vanadium is released into the environment of the fuel cell or electrolyser, its impact on the electrolyte or the catalysts will be very low.

In certain embodiments, the content of the main dopant within the main layer is between 1 ppm and 10 at. %, preferably between 10 ppm and 1 at. %, more preferably between 0.2 and 0.5 at. %.

In certain embodiments, the thickness of the anticorrosion coating is between 5 nm and 5 μm, preferably between 10 nm and 1 μm, more preferably between 100 nm and 300 nm.

In certain embodiments, the anticorrosion coating comprises a plurality of superposed layers, preferably between 2 and 10 layers, the material of the main layer consisting of a main material, and the anticorrosion coating comprising at least one secondary layer based on a secondary material that is different from the main material. Such a multilayer structure can reinforce the mechanical strength of the coating, each interface between two distinct layers contributing to diverting any cracks which appear in the material. Consequently, it is possible to reduce the risk of a crack propagating to the substrate, thus enabling the substrate to remain protected against corrosion.

In certain embodiments, the anticorrosion coating comprises at least three layers, each comprising a different material.

In certain embodiments, each layer of the coating has a thickness between 1 and 500 nm, preferably between 10 and 100 nm.

In certain embodiments, the topmost layer of the anticorrosion coating is a main layer made from the main material. The first line of protection is thus ensured by the main material, which is generally that benefiting from the best anticorrosion properties. However, in other embodiments, the topmost layer of the anticorrosion coating could be a secondary layer.

In certain embodiments, the main material consists of at least 30% by volume, preferably at least 50% by volume, of the anticorrosion coating. A particularly high overall anticorrosion protection is thus ensured.

In certain embodiments, the anticorrosion coating comprises alternating layers based alternately on the main material and the secondary material. Such an alternation is particularly effective for stopping cracks before they reach the substrate.

In certain embodiments, the secondary material is tantalum nitride with a crystallography having a crystal system and/or a doping that is different from the main material. In particular, the secondary material can comprise one or more different dopant elements, or else be undoped. In this way, the secondary material has anticorrosion properties which remain very high and can ensure a satisfactory anticorrosion protection, even in the event of cracking of the main layer.

In certain embodiments, the secondary layer consists substantially of the secondary material.

In certain embodiments, the secondary layer is two-phase or multi-phase. In particular, the secondary layer can have a composition gradient, for example in the direction perpendicular to the substrate.

In certain embodiments, the secondary layer is made substantially of tantalum nitride. By contrast, the secondary layer can have a variation in composition affecting the crystalline structure and/or the doping of the tantalum nitride. In particular, the layers with a crystalline structure gradient have the advantage of improving the accommodation of stresses between a given layer and the layer below, which improves the mechanical properties of the entire system, by limiting cracks and/or delamination of the coating at the interfaces. The doping gradient can, in the same way, better accommodate two successive layers, by avoiding a sudden change in composition which could generate a mechanically weaker interface.

In certain embodiments, the main layer is deposited using a co-sputtering method. This co-sputtering process can, in particular, combine high-power impulse magnetron sputtering (HiPIMS), using a tantalum target and magnetron sputtering using a target comprising the dopant element. Examples of high-power impulse magnetron sputtering methods are described, in particular, in document FR 3 097 237.

The present disclosure also relates to an acid electrolyte fuel cell or electrolyser, comprising at least one component according to any one of the preceding embodiments.

In certain embodiments, the fuel cell is a proton-exchange membrane fuel cell (PEMFC).

In certain embodiments, the fuel cell is a phosphoric acid fuel cell (PAFC).

In certain embodiments, the fuel cell is of the type supplied with gaseous fuel, preferably molecular hydrogen H₂.

In the present disclosure, it is considered that a part or a portion of a part is produced based on a given material when this material represents the majority of the material, by mass, in the composition of the part or portion of the part.

In the present disclosure, it is considered that a part or portion of a part is substantially produced from a given material when it is at least 80%, preferably 90%, more preferably 99%, formed by this material.

The above-mentioned features and advantages, and others, will become apparent on reading the detailed description which follows, of exemplary embodiments of the proposed component and fuel cell. This detailed description refers to the attached drawings.

### BRIEF DESCRIPTION OF THE FIGURES

The attached drawings are schematic and primarily aim to illustrate the principles of the disclosure.

In these drawings, from one figure to another, identical elements (or parts of elements) are identified by the same reference signs. In addition, elements (or element portions) belonging to the various exemplary embodiments but having an equivalent function, are referenced in the figures by reference numbers incremented by 100, 200, etc.

FIG. 1 is a schematic view of a fuel cell according to the disclosure.

FIG. 2 is a diagram of a cell of the fuel cell of FIG. 1.

FIG. 3 is a schematic view of a first exemplary component.

FIG. 4 schematically illustrates a device for producing a coating according to the disclosure.

FIG. 5 is a graph illustrating the results of corrosion tests in the context of the first example.

FIG. 6 illustrates, in cross-section and from the front, the microstructure of a coating of cubic TaN deposited by a high-power impulse magnetron sputtering method.

FIG. 7 is a graph illustrating the results of corrosion tests in the context of a second example.

FIG. 8 is a schematic view of a third exemplary component.

FIG. 9 is a graph illustrating the results of corrosion tests in the context of the third example.

FIG. 10 illustrates, in cross-section and from the front, the microstructure of a coating of hexagonal TaN deposited by a high-power impulse magnetron sputtering method.

FIG. 11 illustrates, by way of comparison, in cross-section and from the front, the microstructure of a coating of hexagonal TaN deposited by a conventional magnetron sputtering method.

### DESCRIPTION OF THE EMBODIMENTS

In order to make the disclosure more concrete, examples of components and fuel cells are described in detail below, with reference to the attached drawings. It is recalled that the invention is not limited to these examples.

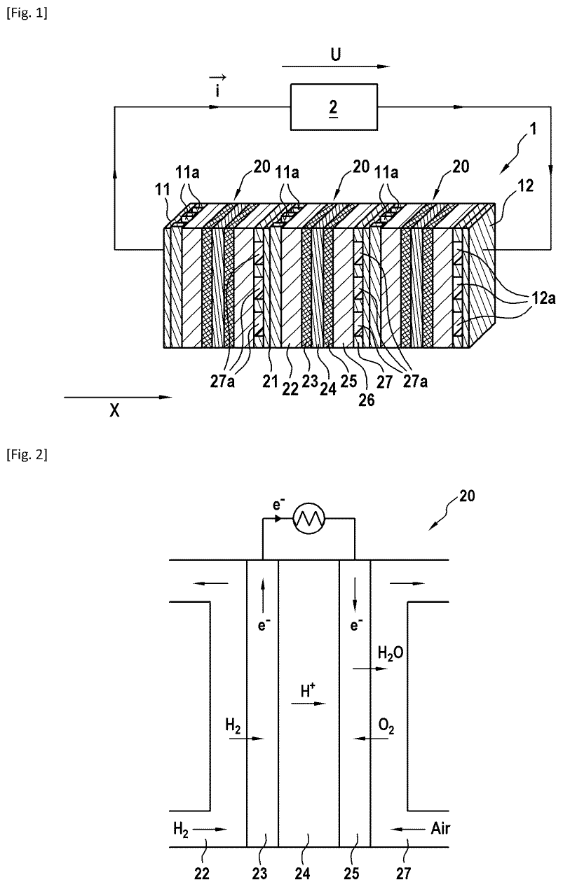

FIG. 1 schematically illustrates a fuel cell 1 according to the invention. Such a fuel cell comprises two end plates 11, 12 between which cells 20 are stacked in a stacking direction X. Each cell 20 comprises, in order (from left to right in FIG. 1), a first bipolar plate 21, a first diffusion layer 22, a first electrode 23, an electrolyte 24, a second electrode 25, a second diffusion layer 26 and a second bipolar plate 27.

The function of the bipolar plates 21, 27 is to dispense the reagents and, where appropriate, the heat transfer fluid which cools the cell when said cell has reached its nominal operating regime: the bipolar plates 21, 27 are thus provided with a network of channels 21a, 27a on each of their faces. Another function of the bipolar plates 21, 27 is to conduct electrical current between the successive cells 20. Thus, each bipolar plate 21, 27 is situated at the interface between two successive cells 20, the second bipolar plate 27 of the N^{th} cell 20 constituting the first bipolar plate 21 of the (N+1)^{th} cell 20, thus electrically connecting in series the N^{th} and (N+1)^{th} cells 20.

The end plates 11, 12 play the same role as the bipolar plates 21, 27, except that they are provided at the ends of the stack, thus respectively closing the left side of the first cell 20 and the right side of the last cell 20: the end plates 11, 12 therefore only having a network of channels 11a, 12a on one of their faces. Also conductive, they constitute the terminals of the overall fuel cell: thus, the terminals of the electrical load 2 to be supplied, for example a motor, can be connected to each of the end plates 11, 12.

The function of the diffusion layers 22, 26 is to enable the diffusion of the reagents from the bipolar plate 21, 27 to the electrode 23, 25 concerned, and reaction products from this same electrode 23, 25 to the bipolar plate 21, 27. This diffusion can, in particular, be made possible by grooves or a network of pores, for example.

The electrodes 23, 25 are the seat of the electrochemical half-reactions ensuring the operation of the fuel cell 1: the first electrode 23 thus forms the anode, while the second electrode 25 forms the cathode. The electrodes 23, 25 are porous, preferably microporous, in order to provide access for the reagents and evacuation of the reaction products. The first electrode 23 and/or the second electrode 25 is provided with a catalyst that can catalyse the electrochemical half-reaction in question.

The function of the electrolyte 24 is to allow the migration of certain ions between the anode 23 and the cathode 25, while preventing the passage of electrons coming from the oxidation half-reaction at the anode 23. The electrons e; thus formed are conducted to the cathode 25 of the immediately preceding cell 20, where they are consumed by the reduction half-reaction. The electrons formed by the first cell 20 are, for their part, collected by the first end plate 11, supply the load 2, and return to the cathode 25 of the last cell 20 via the second end plate 12.

FIG. 2 shows more precisely the operation of a cell 20 in the context of a first embodiment. In this first example, the fuel cell 1 is a proton-exchange membrane fuel cell (PEMFC).

In such a fuel cell 1, the fuel added at the anode 23 is molecular hydrogen H₂ while air is added at the cathode 25. The electrolyte 24 is formed by a proton-exchange membrane capable of allowing the passage of H⁺ ions while retaining the electrons e⁻. The proton-exchange membrane also prevents the passage of any gas. Platinum is used as catalyst both at the anode 23 and the cathode 25.

The anode 23 is thus the seat of the following oxidising half-reaction:

H₂→2H⁺+2e⁻

The cathode 25 is in turn the seat of the following reduction half-reaction:

4H⁺+4e⁻+O₂→2H₂O

Thus, overall, the operating equation of the fuel cell 1 is the following:

2H₂+O₂→2H₂O

In such a proton-exchange membrane fuel cell, the membrane 24 plays the role of an acid electrolyte. More specifically, it may be a membrane based on Nafion (registered trademark), in other words a fluoropolymer copolymer based on sulfonated tetrafluoroethylene, or even a membrane based on polybenzimidazole doped with phosphoric acid.

Due to this highly corrosive environment, the end plates 11, 12 and bipolar plates 21, 27 must be capable of resisting corrosion while continuing to provide their electrical conduction function.

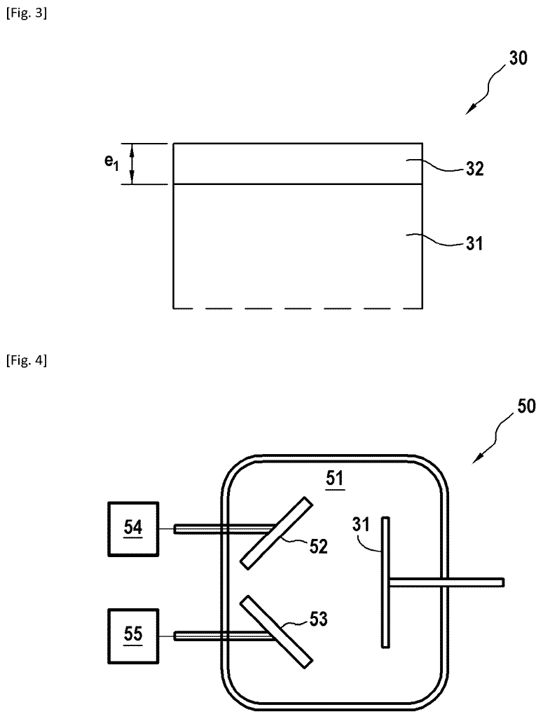

FIG. 3 schematically shows such a component, designated by the generic reference 30, according to the first exemplary embodiment. The component 30 thus comprises a substrate 31, made for example from Inox 316L, and an anticorrosion coating 32 deposited on the substrate 31, the anticorrosion coating 32 having a thickness e₁ of 380 nm.

In this first example, the anticorrosion coating 32 comprises a single layer made of tantalum nitride TaN doped using zirconium Zr. This compound, of formula Ta₁₋ₓZrₓN (with 0<X<1), has a stable crystalline structure in which the zirconium atoms substitute for tantalum atoms Ta, thus forming a solid solution.

In the present example, the crystal system of this compound is cubic, having more precisely a face-centred cubic structure. However, this compound is also capable of crystallising in hexagonal form, which is also entirely suitable.

In the present example, zirconium is present at a level of 5.8+/−0.6 at. % within this compound.

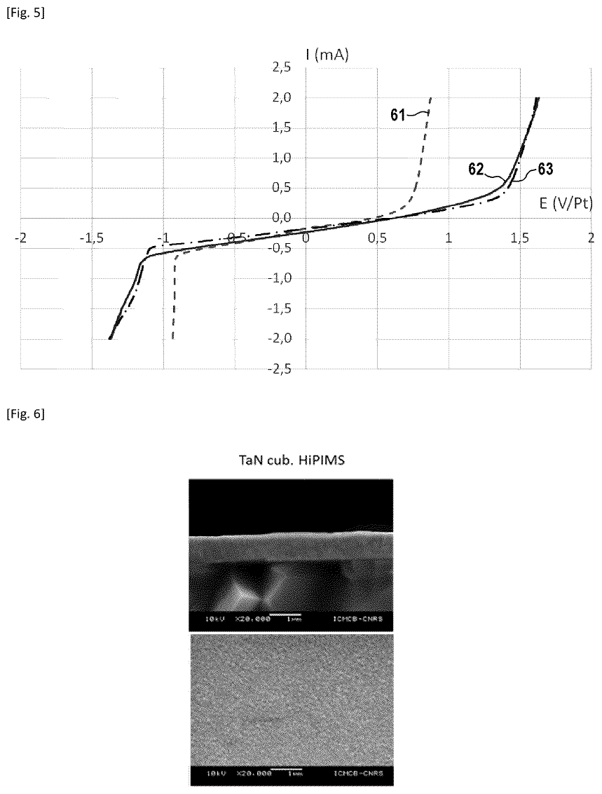

Such an anticorrosion coating 32 can be deposited on the substrate 31 using the device 50 shown schematically in FIG. 4. This device 50 can perform a co-sputtering by high-power impulse magnetron sputtering.

The device 50 comprises a chamber 51 intended to receive a plasmagenic gas, for example formed of a mixture of argon and nitrogen. The device further comprises a source of plasmagenic gas (not shown) in communication with the chamber 51. The pressure in the chamber 51 is fixed between 0.1 and 7 Pa; the gas mixture comprises between 1 and 95 at. % nitrogen. In the present example, the pressure is fixed at 0.15 Pa and the gaseous mixture of argon and nitrogen comprises 10% nitrogen.

The chamber 51 comprises a tantalum target 52, constituting a first cathode, and a zirconium target 53, constituting a second cathode. The two targets 52 and 53 are deposited on the same side of the chamber 51, forming an angle of 90° with respect to one another.

The substrate 31 to be covered constituting the anode, is deposited within the chamber 51 opposite the targets 52, 53, in a manner that is perpendicular and centred with respect to the bisector of the two targets 52, 53.

In the present example, the first target 52 comprises tantalum at more than 99% in atomic percent, and preferably at more than 99.9% in atomic percent. The second target 53 comprises zirconium at more than 99% in atomic percent, and preferably at more than 99.9% in atomic percent.

During the coating, the tantalum target 52 is polarised by superposing a continuous polarisation and a pulsed polarisation. The polarisation of the first target 52 is imposed by a first electrical supply device 54 comprising a voltage pulse generator and a DC voltage generator electrically connected to the target 52. The voltage pulse generator can impose the pulsed polarisation at the tantalum target 52. The DC voltage generator can impose the continuous polarisation at the target 52. Such a configuration is described, in particular in document FR 3 097 237. The width of the pulses can be between 1 and 500 μs, their frequency between 100 and 5000 Hz, and their voltage between 300 and 2000 V. In the present example, the pulse width is equal to 30 μs, their frequency is equal to 1000 Hz and their voltage is equal to 1000 V.

Analogously, the zirconium target 53 is polarised using a second electrical supply device 55 configured to ensure a radiofrequency polarisation

In the chamber 51, the application of a voltage between the target 52 and the substrate 31 in the presence of an atmosphere of nitrogen enables a plasma to be created. Electrons are generated by the target 52 and can ionise, by collision, the atoms constituting the plasma. It is possible to introduce, into the chamber 51 close to the target 52, one or more permanent magnets, not shown, the magnetic field of which confines the electrons generated close to the target 51 and increases the probability that the collision between an electron and an atom of the plasma will take place. When such a collision takes place, a high energy species is generated, and this can bombard the target 52 and remove particles from the target 52, by elastic impact. The particles removed from the target 52 in this way can then be deposited on the substrate 31 in order to form the coating 32.

Analogously and simultaneously, particles from the target 53 are also removed at the target 53 and sputtered on the substrate 31. It is possible to adjust the quantity of dopant particles, in this case zirconium, in the coating 32 by adjusting the electrical power supplied to the second target 53. For example, in the present example, a power of 5 W is applied on the zirconium target 53.

The substrate 31 can be heated during the coating by a heating member that is not shown. Alternatively, the substrate 31 may not be heated during the coating. The temperature of the substrate can, for example, be greater than or equal to 20° C. during the coating, for example between 20° C. and 600° C., or even between 30° C. and 500° C. The temperature makes it possible to supply the substrate with thermal energy, and thus enables a certain mobility of the atoms, promoting the recombination of the atoms being deposited at the surface of the substrate 31.

FIG. 5 shows the results of corrosion tests relating to this first exemplary embodiment. This cyclic voltammetry test was carried out in the laboratory, at ambient temperature, by immersing a working electrode in a bath of 0.5 mol/L phosphoric acid, said electrode being made of the material to be tested, as well as a counter-electrode made of platinum, while varying the potential applied to the working electrode relative to the counter-electrode and recording its current response.

Curve 61 corresponds to a working electrode made of Inox 316L, in other words the material of the substrate 31. Curve 62 corresponds to a working electrode made of 316L that is integrally covered with a coating of cubic tantalum nitride, doped to a level of 5.8+/−0.6 at. % with zirconium Zr, in other words a coating 32 according to the first exemplary embodiment. Curve 63 corresponds to a working electrode made of 316L that is integrally covered with a coating of cubic tantalum nitride, doped to a level of 6.0+/−0.4 at. % with zirconium Zr, in other words a coating 32 according to a variant embodiment.

It can therefore be seen in FIG. 5 that curves 62 and 63, corresponding to the anticorrosion coatings 32 according to the first exemplary embodiment and its variant, have significantly broader stability plateaus than curve 61 corresponding to the substrate material 31, thus confirming the protection of the substrate 31 by the anticorrosion coating 32.

This test also makes it possible to measure the corrosion potential and current for these different samples:

TABLE 1

| | 316L | Ta₁₋ₓZrₓN - 5.8% | Ta₁₋ₓZrₓN - 6.0% |
|---|---|---|---|
| E_{corr} (V/Pt) | 0.4 | 0.6 | 0.6 |
| I_{corr} (μA/cm²) | 27.2 | 18.4 | 17.5 |

It can also be seen that the corrosion current I_{corr} of the anticorrosion coatings 32 according to the present exemplary embodiment and its variant is more than 30% lower than that of the comparative sample of the substrate 31, thus confirming the excellent anticorrosion properties of these coatings.

Furthermore, FIG. 6 illustrates the microstructure of a cubic tantalum nitride coating, in cross-section and from the front, deposited by a high-power impulse magnetron sputtering method according to the present example. The scale shown at the bottom of each image corresponds to 1 μm. It can be seen in these two images that the microstructure of the coating is thin and homogeneous, which implies good mechanical strength with, in particular, good resistance to the propagation of cracks within the coating. By way of comparison, such a coating deposited by a conventional magnetron sputtering process leads to an easily fractured columnar microstructure.

Furthermore, it is important to note that the anticorrosion coatings 32 according to the first exemplary embodiment and its variant have a conductivity much greater than 100 S/cm, which ensures that they have a sufficient conductivity for satisfactorily conducting the electrons within the fuel cell or electrolyser. More specifically, at 160° C., the conductivity of the cubic tantalum nitride deposited by high-power impulse magnetron sputtering is equal to 538 S/cm.

In this first example, the tantalum nitride TaN forming the anticorrosion coating 32 is doped using zirconium. However, in other examples, other dopant elements, from the transition metals or lanthanides, could be used in place of or in addition to zirconium.

In particular, in a second exemplary embodiment, the anticorrosion coating comprises a single layer made of tantalum nitride TaN doped using hafnium Hf. This compound, of formula Ta₁₋ₓHfₓN, has a stable crystalline structure in which the zirconium atoms substitute for tantalum atoms Hf, thus forming a solid solution.

In this second example, the crystal system of this compound is also cubic, having more precisely a face-centred cubic structure. However, this compound is also capable of crystallising in hexagonal form, which is also entirely suitable.

In this second example, the hafnium is present at a level of 5.7+/−0.5 at. % within this compound.

A method entirely analogous to that of the first example can be used to deposit this anticorrosion coating on the substrate, by replacing the zirconium target 53 by a hafnium target.

Analogously to FIG. 5, FIG. 7 show the results of corrosion tests concerning this second exemplary embodiment. This cyclic voltammetry test was carried out under the same conditions as the test carried out for the first exemplary embodiment.

Curve 161 corresponds to a working electrode made of Inox 316L, in other words the material of the substrate. Curve 162 corresponds to a working electrode made of 316L that is integrally covered with a coating of cubic tantalum nitride, doped to a level of 5.7+/−0.7 at. % with hafnium Hf, in other words a coating according to the second exemplary embodiment. Curve 163 corresponds to a working electrode made of 316L that is integrally covered with a coating of cubic tantalum nitride, doped to a level of 5.3+/−0.5 at. % with hafnium Hf, in other words a coating according to a variant of the second exemplary embodiment.

It can therefore be seen in FIG. 7 that curves 162 and 163, corresponding to the anticorrosion coatings according to the second exemplary embodiment and its variant, have significantly broader stability plateaus than curve 161 corresponding to the substrate material, thus confirming the protection of the substrate by the anticorrosion coating.

This test also makes it possible to measure the corrosion potential and current for these different samples:

TABLE 2

| | 316L | Ta₁₋ₓHfₓN - 5.3% | Ta₁₋ₓHfₓN - 5.7% |
|---|---|---|---|
| E_{corr} (V/Pt) | 0.4 | 0.6 | 0.5 |
| I_{corr} (μA/cm²) | 27.2 | 22.1 | 23.7 |

It can also be seen that the corrosion current I_{corr} of the anticorrosion coatings according to the second exemplary embodiment and its variant is more than 10% lower than that of the comparative sample of the substrate, thus confirming the excellent anticorrosion properties of these coatings.

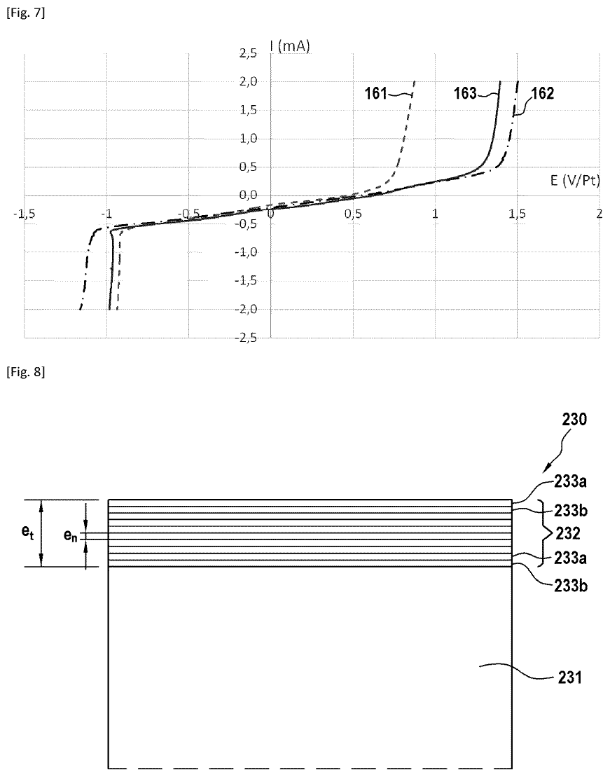

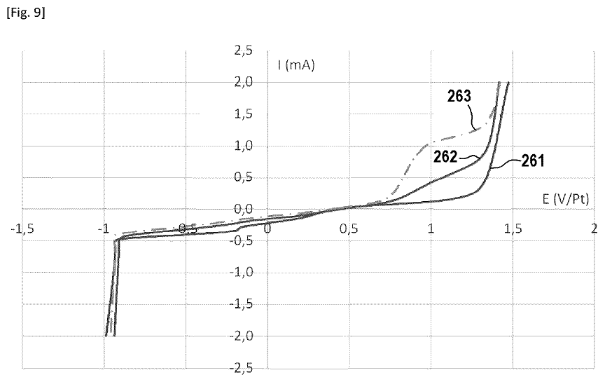

FIG. 8 schematically shows a component 230 according to a third exemplary embodiment. Again, the component 230 comprises a substrate 231, made for example of Inox 316L, and an anticorrosion coating 232 deposited on the substrate 231.

In this third example, the anticorrosion coating 232 comprises a plurality of superposed layers 233, more precisely ten layers in the present example, each having a thickness eₙ of 50 nm for a total coating thickness of 500 nm.

In this third example, the anticorrosion coating 232 comprises two types of layers 233 deposited alternately: main layers 233a, made of a main material, and secondary layers 233b, made of a secondary material. Here, the topmost layer of the anticorrosion coating 232, exposed to the environment, is a main layer 233a.

In this third example, the main material, in other words the material of the main layers 233a, is cubic tantalum nitride TaN doped using zirconium Zr. In particular, this main material can correspond to the material of the anticorrosion coating 32 of the first exemplary embodiment.

In this third example, the secondary material, in other words the material of the secondary layers 233b, is undoped hexagonal tantalum nitride TaN.

This multilayer anticorrosion coating 232 can be deposited on the substrate 231 using the same device 50 as shown schematically in FIG. 4 and described in the context of the first exemplary embodiment. More specifically, the main layers 233a can be deposited by co-sputtering as described above; the secondary layers 233b can for their part be deposited by high-power impulse magnetron sputtering using the first target 52 only, in other words applying no power to the second target 53.

Thus, it is possible to produce all of the layers 233 of the coating 232 in a single step and using a single device 50, by controlling, over time, the electrical polarisations applied to each of the targets 52, 53.

In particular, in this third example, the pressure in the chamber 51 is fixed at 5 mTorr, i.e. approximately 0.7 Pa; the gaseous mixture is composed of argon and nitrogen with 25 at. % nitrogen. The main layers are deposited with the same pulse parameters as those of the first exemplary embodiment. The secondary layers are deposited with the following pulse parameters: pulse width equal to 50 μs, pulse frequency to 1000 Hz, and pulse voltage equal to 700 V.

The anticorrosion performance of the main material was described in the context of the first exemplary embodiment. FIG. 9 illustrates the corrosion test results concerning the secondary material. This cyclic voltammetry test was carried out under the same conditions as the test carried out for the first exemplary embodiment, except that the working electrode has been tested in a plurality of phosphoric acid baths with increasing concentrations: 0.1 mol/L; 0.5 mol/L; and 1 mol/L.

The three curves 261, 262 and 263 thus correspond to a same working electrode made of Inox 316L integrally covered with a coating of undoped hexagonal tantalum nitride. Curve 261 corresponds to a bath concentration of 0.1 mol/L; curve 262 corresponds to a bath concentration of 0.5 mol/L; and curve 263 corresponds to a bath concentration of 1 mol/L.

It can therefore be seen in FIG. 9 that curves 261, 262 and 263, corresponding to the secondary material, also have significantly broader stability plateaus than that of the substrate 231 made of Inox 316L.

This test also makes it possible to measure the corrosion potential and current for Inox 316L (Table 3) and the undoped hexagonal tantalum nitride (Table 4) for these different bath concentrations.

TABLE 3

| | 0.1 mol/L | 0.5 mol/L | 1 mol/L |
|---|---|---|---|
| E_{corr} (V/Pt) | 0.9 | 0.4 | 0.5 |
| I_{corr} (μA/cm²) | 14 | 27.2 | 49.7 |
| Stability range (V) | 2.1 | 1.4 | 1.4 |

TABLE 4

| | 0.1 mol/L | 0.5 mol/L | 1 mol/L |
|---|---|---|---|
| E_{corr} (V/Pt) | 0.4 | 0.4 | 0.4 |
| I_{corr} (μA/cm²) | 17.6 | 22.2 | 35.2 |
| Stability range (V) | 2.2 | 2.1 | 2.1 |

It can also be seen that the corrosion current I_{corr} of the undoped hexagonal tantalum nitride increases much less quickly than that of Inox 316L with the increase in the acidity of the medium, thus revealing a better corrosion resistance.

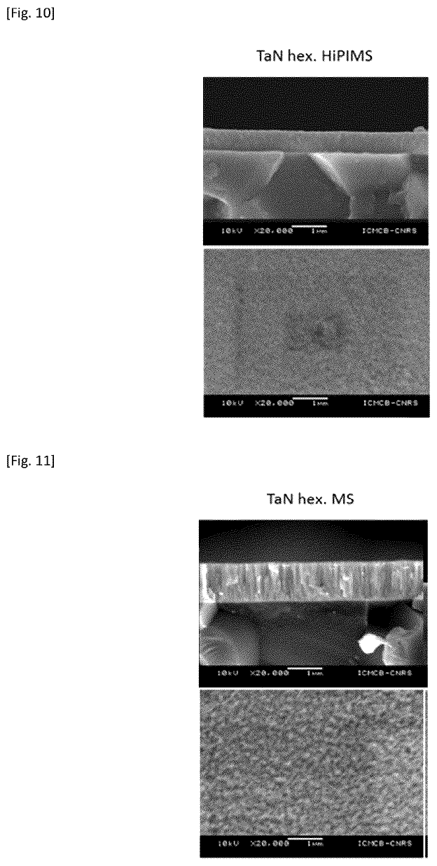

Furthermore, FIG. 10 illustrates the microstructure of a hexagonal tantalum nitride coating, in cross-section and from the front, deposited by a high-power impulse magnetron sputtering method according to the present example. The scale shown at the bottom of each image corresponds to 1 μm. It can be seen in these two images that, in the same manner as for its cubic homologue in FIG. 6, the microstructure of the coating is thin and homogeneous, which implies good mechanical strength with, in particular, good resistance to the propagation of cracks within the coating. By way of comparison, such a coating deposited by a conventional magnetron sputtering method leads to an easily fractured columnar microstructure, as is visible in FIG. 11.

Moreover, the inventors have determined that the cubic and hexagonal phases of tantalum nitride have significantly different Young's moduli. More specifically, the Young's modulus measured by nano-indentation of the cubic phase is 430 GPa, whereas that of the hexagonal phase is 560 GPa.

Consequently, the cracks have a tendency to be diverted at the interface between a main layer 233a and a secondary layer 233b. Therefore, the superposition of a plurality of alternated main layers 233a and secondary layers 233b can significantly brake the propagation of cracks within the coating 232.

Finally, it is important to note that hexagonal tantalum nitride has an even greater conductivity than that of cubic tantalum nitride, which further improves its electrical conduction function. Thus, at 160° C., the conductivity of the cubic tantalum nitride deposited by high-power impulse magnetron sputtering is equal to 4,045 S/cm.

In this third example, the main material is doped cubic tantalum nitride, while the secondary material is undoped hexagonal tantalum nitride. However, other multilayer configurations are also possible.

For example, the main material can be hexagonal tantalum nitride, or even two-phase tantalum nitride, with a dominance of cubic or hexagonal. The main material can also comprise a different dopant element, or even one or more additional dopant elements.

For example, the secondary material can also be doped. However, if the crystal system of the second material is the same as that of the main material, the doping will preferably be different to that of the main material.

Thus, in particular, in a fourth exemplary embodiment, the coating comprises alternative layers of doped hexagonal tantalum nitride and undoped hexagonal tantalum nitride.

In a fifth exemplary embodiment, the coating comprises alternated layers of doped hexagonal tantalum nitride and doped or undoped cubic tantalum nitride.

Although the present invention has been described by referring to specific exemplary embodiments, it is obvious that modifications and changes can be made to these examples without going beyond the general scope of the invention as defined by the claims. In particular, the individual features of different embodiments illustrated or mentioned can be combined in additional embodiments. Consequently, the description and the drawings should be considered as illustrating rather than limiting.

It is also obvious that all the features described in reference to a method can be transposed, alone or in combination, to a device, and inversely, all the features described in reference to a device can be transposed, alone or in combination, to a method.

1. A component for an acid electrolyte fuel cell or electrolyser, comprising an electrically conductive substrate, and an anticorrosion coating deposited on at least one surface of the substrate, wherein the anticorrosion coating comprises at least one main tantalum-nitride-based layer doped with one or more dopant elements chosen from the family of transition metals or lanthanides.

2. The component according to claim 1, wherein the substrate is metallic, preferably made of steel.

3. The component according to claim 1, wherein the crystal system of the tantalum nitride of the main layer is hexagonal or cubic.

4. The component according to claim 1, wherein the total content of dopants within the main layer is between 1 ppm and 10 at. %.

5. The component according to claim 1, wherein the main dopant element is chosen from zirconium, hafnium, vanadium, titanium, niobium, chromium or molybdenum.

6. The component according to claim 1, wherein the thickness of the anticorrosion coating (32) is between 5 nm and 5 μm.

7. The component according to claim 1, wherein the anticorrosion coating comprises a plurality of superposed layers,
wherein the material of the main layer consists of a main material, and
wherein the anticorrosion coating comprises at least one secondary layer based on a secondary material that is different from the main material.

8. The component according to claim 7, wherein the main material consists of at least 30% by volume of the anticorrosion coating.

9. The component according to claim 7, wherein the anticorrosion coating comprises alternating layers based alternately on the main material and the secondary material.

10. The component according to claim 7, wherein the secondary material is tantalum nitride having a crystal system and/or a doping that is different from the main material.

11. An acid electrolyte fuel cell or electrolyser, comprising at least one component according to claim 1.

12. A fuel cell or electrolyser according to claim 11, of the proton-exchange membrane fuel cell (PEMFC) type or of the phosphoric acid fuel cell (PAFC) type, supplied with gaseous fuel, preferably molecular hydrogen H₂.
